(19) United States
(12) Patent Application Publication
(10) Pub. No.: US 2018/0250106 A1
(43) Pub. Date: Sep. 6, 2018

(54) IRRIGATION CANNULA, IN PARTICULAR FOR AN ENDODONTIC IRRIGATION DEVICE

(71) Applicant: PRODUITS DENTAIRES SA, Vevey (CH)

(72) Inventors: Nicolas GEHRIG, Chardonne (CH); David BRENDLEN, Vevey (CH)

(73) Assignee: PRODUITS DENTAIRES SA, Vevey (CH)

(21) Appl. No.: 15/758,676

(22) PCT Filed: Sep. 16, 2015
(86) PCT No.: PCT/EP2015/071263

§ 371 Date: Mar. 8, 2018

(51) Int. Cl. A61C 17/02; A61C 5/50

(52) U.S. Cl. CPC A61C 17/0208; A61C 5/40; A61C 5/50

(57) ABSTRACT

Disclosed is an irrigation needle including an active part extending between a first end intended to be connected to an irrigation device and a second closed end, a central channel extending inside the active part and open at the first end and at least one opening arranged radially on the active part in the vicinity of the second end and communicating with the central channel for distributing an irrigation solution. The needle is obtained as one piece using a thermoplastic micro-injection moulding method.

The present invention relates to an irrigation needle particularly intended to equip an endodontic irrigation device or system for irrigating dental root canals following the shaping thereof.

Irrigation is an integral step in dental root canal treatment procedures. During this step, an irrigation solution is injected into the dental root canal, following the shaping thereof, for the purpose of eliminating any detritus and debris and also for the purpose of disinfecting. The irrigation solutions that are generally used are sodium hypochlorite (disinfectant, antibacterial agent), EDTA (Ethylenediaminetetraacetic acid), hydrogen peroxide or chlorhexidine.

In general, the irrigation solution is injected via a cylindrical or conical irrigation needle, one end of which is connected to a device for supplying the solution. The needle is shaped so that it can be inserted into the root canal without causing any damage. Openings are made in the needle to allow the solution to be distributed.

In order to be effective, the needle also must be flexible in order to be able to follow the shape of the root canal, which is generally curved. To this end, it is known for needles to be made of stainless steel or nickel titanium alloy, which is a widely used material in the dental field, particularly for its flexibility (see US 2003/0013064, for example). However, shaping such needles is time-consuming and relatively expensive.

Another problem associated with irrigation is the need to provide proper irrigation and proper cleaning of the canal, whilst preventing the irrigation solution from exceeding the apex of the canal and reaching the periapical tissue, this phenomenon, called extrusion, can create edemas or haematomas. To this end, the end of the needle that is intended to be inserted into the root canal is generally closed or blind and the openings are disposed radially around the needle in the vicinity of this closed end.

A final problem involves preventing any damage to the walls of the canal when inserting or removing the needle.

The object of the present invention is to produce an irrigation needle intended to equip a device for irrigating a dental root canal that is effective and is quick and inexpensive to manufacture. In particular, the aim of the present invention is to provide an irrigation needle that allows the following problems to be addressed:
providing proper distribution of the irrigation solution to ensure proper cleaning of the canal;
limiting the risk that the solution exceeds the apex and reaches the periapical tissue;
limiting the risk of damage caused to the walls of the canal and to its apex when inserting the needle;
providing sufficient flexibility to adapt itself to the shape of the canal;
limiting the manufacturing costs.

The present invention relates to an irrigation needle as claimed in claim 1, as well as to an irrigation system as claimed in claim 9.

The appended drawings schematically show, by way of an example, several embodiments of an irrigation needle according to the invention.

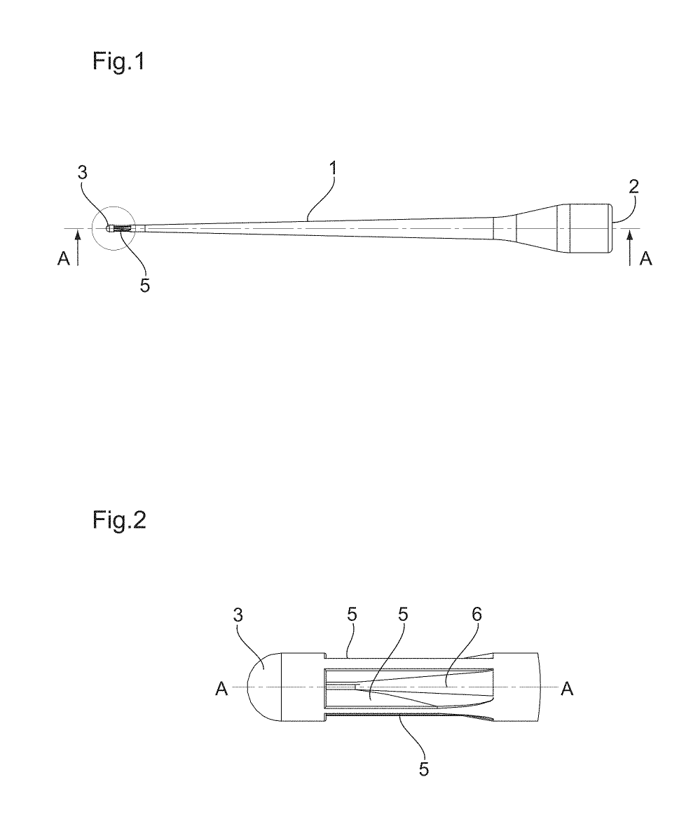

FIG. 1 shows an irrigation needle according to the invention.

FIG. 2 is an enlarged view of the tip of the irrigation needle shown in FIG. 1.

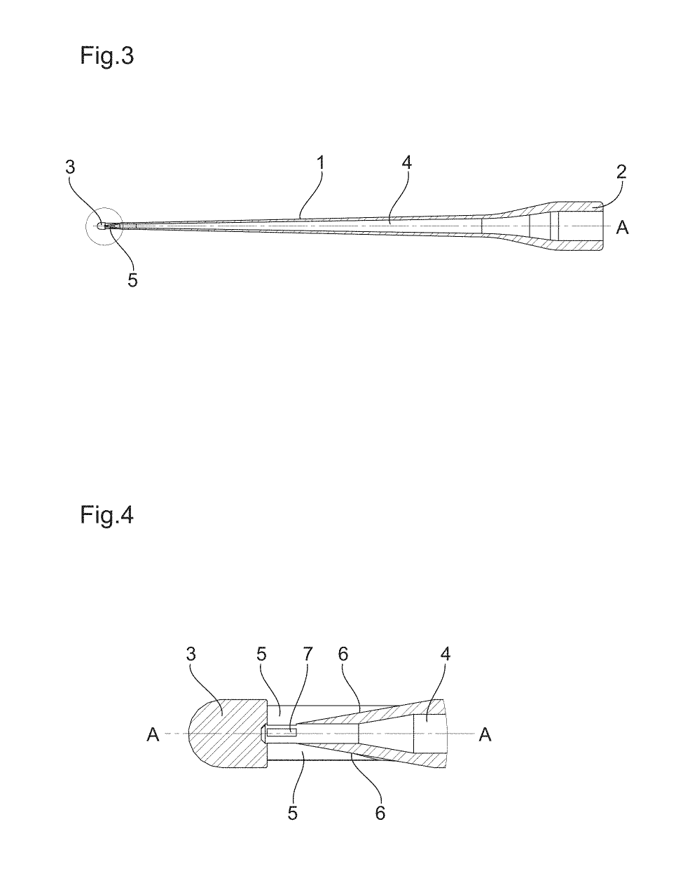

FIG. 3 is a section view of the irrigation needle of FIG. 1 along its longitudinal axis A-A.

FIG. 4 is an enlarged view of the tip of the irrigation needle shown in FIG. 3.

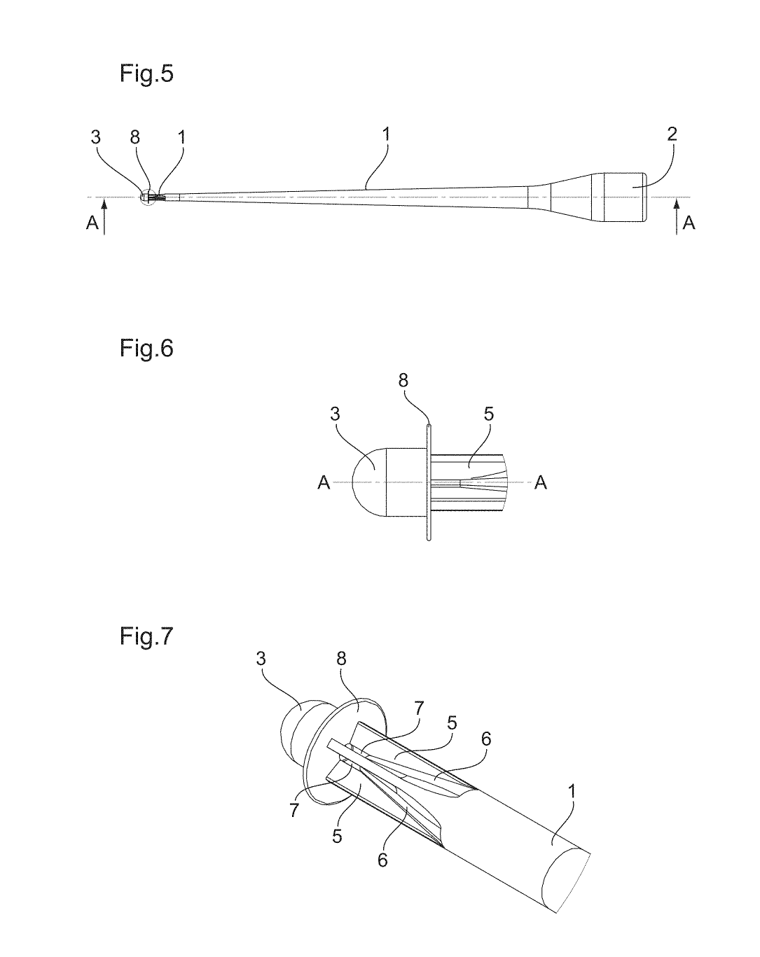

FIG. 5 shows a first variant of the irrigation needle according to the invention.

FIGS. 6 and 7 are enlarged views of the tip of the irrigation needle according to the first variant shown in FIG. 5.

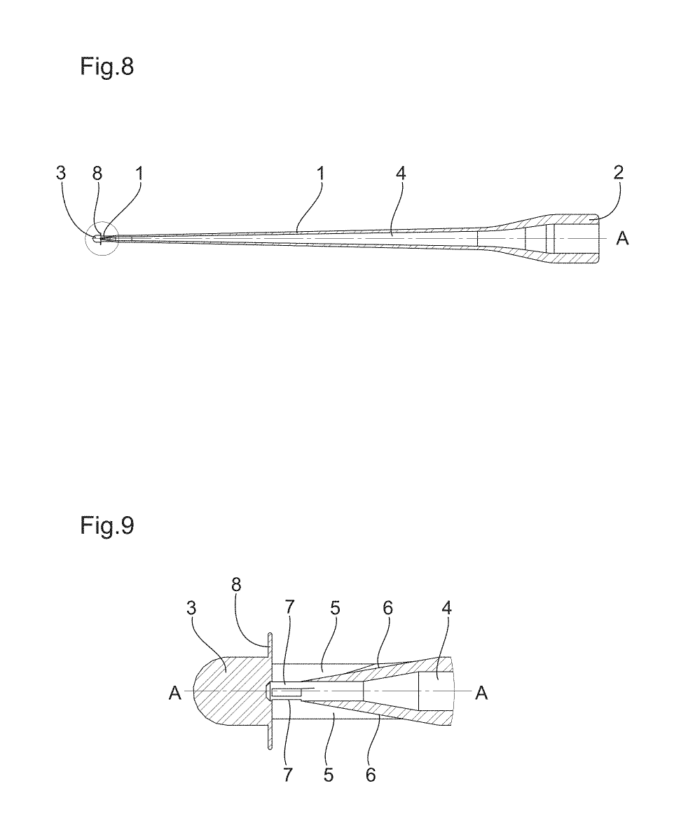

FIG. 8 is a section view along the longitudinal axis A-A of the irrigation needle according to the first variant shown in FIG. 5.

FIG. 9 is an enlarged view of the tip of the irrigation needle shown in FIG. 8.

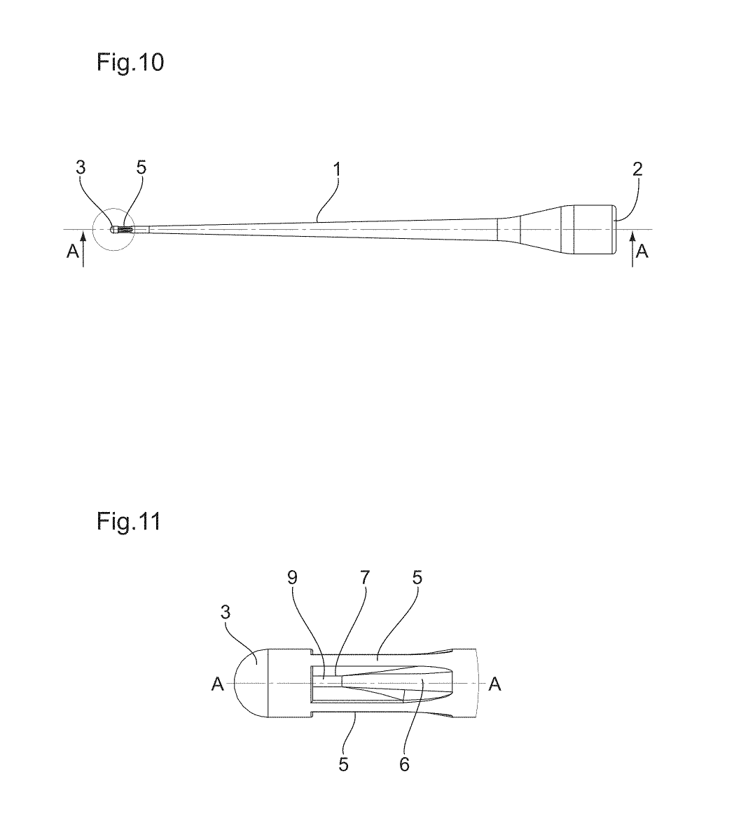

FIG. 10 shows a second variant of the irrigation needle according to the invention.

FIG. 11 is an enlarged view of the tip of the irrigation needle according to the second variant shown in FIG. 10.

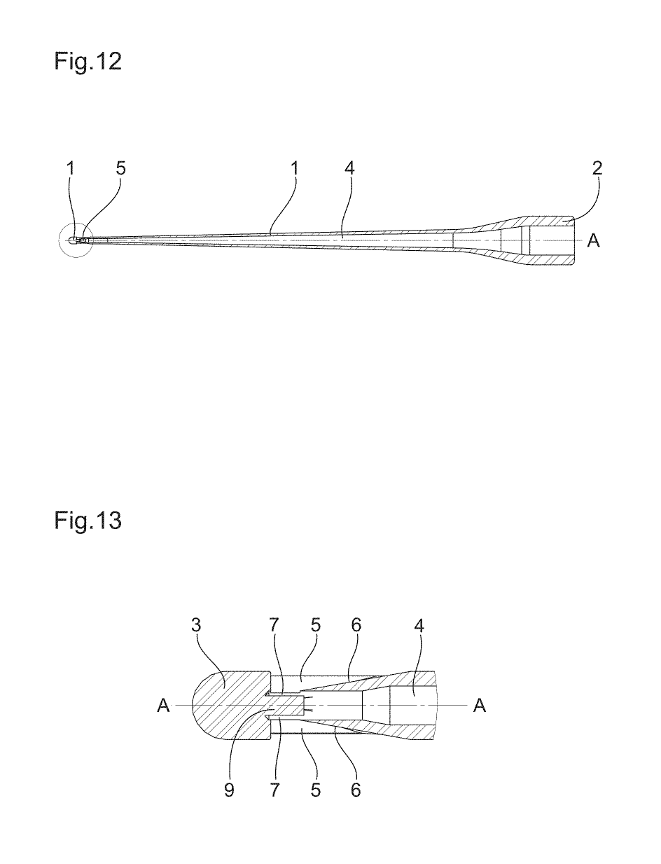

FIG. 12 is a section view along the longitudinal axis A-A of the irrigation needle according to the second variant shown in FIG. 10.

FIG. 13 is an enlarged view of the tip of the irrigation needle shown in FIG. 12.

An irrigation needle according to the invention comprises an active part 1 extending between a first end 2 and a second end 3, called tip. The active part 1 can be curved or straight, cylindrical or conical. The active part 1 is preferably flexible and even more preferably exhibits increasing flexibility from the first end 2 to the second end 3. In the embodiment shown in the figures, the active part 1 extends along a longitudinal axis A-A and is conical, with its diameter tapering from the first end 2 to the tip 3.

The irrigation needle according to the invention is intended to be connected by its first end 2 to an irrigation device or system (not shown) that conventionally comprises a source of irrigation solution and means for distributing said solution from the source to the needle. To this end, the first end 2 can assume any suitable shape. In particular, it can involve a Luer-lock type connector. The irrigation device can be formed, for example, by a manually activated syringe or by a pressurised container, such as a spray, allowing an irrigation solution to be distributed with a constant flow.

In order to allow irrigation, the irrigation needle comprises a central channel 4 extending inside the active part 1 between the first end 2 and the tip 3. The central channel 4 is open at the first end 2 to communicate with the irrigation device to which the needle is connected and to thus receive the irrigation solution. The central channel 4 is preferably closed at the tip 3 and does not pass through this tip 3, in order to prevent the irrigation solution from being directly distributed towards the apex of the root canal.

In addition to being closed, the tip 3 preferably is rounded in order to reduce any risks of perforation or damage to the walls of the canal when inserting the irrigation needle.

Finally, the irrigation needle according to the invention comprises at least one, but preferably two, three or four openings 5 arranged radially on the active part 1 in the vicinity of the tip 3 and communicating with the central channel 4 for distributing the irrigation solution. Preferably, and as shown in the figures, the openings 5 are elongated and extend parallel to the longitudinal axis A-A of the needle. Also preferably, the openings 5 are distributed so as to be diametrically opposed in pairs.

Preferably, and as shown in FIGS. 2, 4, 6, 7, 9, 11 and 13, the openings 5 are bevelled and comprise an inclined plane 6 produced in the wall of the active part 1 of the needle. The inclined plane 6 of an opening 5 extends from a perforation 7 in the central channel 4 to the outer surface of the active part 1 towards the first end 2 of the needle. The purpose of this bevelled shape of the openings 5 is to direct the flow of the irrigation solution towards the first end 2 of the active part 1, i.e. towards the top of the root canal and thus opposite the apex when the needle and its active part (1) are inserted into the canal. Indeed, with bevelled openings 5, the angle of distribution of the irrigation solution exiting these openings 5 is reduced towards the tip 3 and the apex of the canal and is basically directed towards the first end 2 of the needle.

Clearly, the irrigation needle according to the invention is designed to be able to be inserted, with the tip 3 first, into a previously shaped root canal, without causing damage, whilst allowing the irrigation solution to be injected into said canal. Similarly, the openings 5 are dimensioned to ensure optimal distribution of the irrigation solution.

According to a specific feature of the invention, the irrigation needle is obtained by thermoplastic micro-injection. A mould of the needle is produced that reproduces all the elements of the needle and particularly the central channel 4, the first end 2, the tip 3 and the openings 5. A suitable plastic material such as, for example, PE or PP plastics, is then injected into said mould according to the principles of thermoplastic micro-injection. Preferably, the plastic material that is used is a high-flow plastic to ensure suitable filling of the mould given the small size of the mould, of the openings 5 and of the central channel 4, in particular.

The irrigation needle that is thus obtained is immediately ready to be used without having to implement another machining step and provides a very smooth surface finish, limiting any damage to the walls of the canal. Furthermore, the use of plastic materials ensures the flexibility of the needle, whilst limiting the production costs.

This mode of production by thermoplastic micro-injection thus allows the production capacities to be increased and the costs to be reduced, whilst ensuring that the irrigation needle that is obtained exhibits all the required properties: flexibility, size, undamageable surface, effectiveness.

In a first variant of the invention shown in detail in FIGS. 5 to 9, the irrigation needle also has a flexible collar 8 in the vicinity of its tip 3. When idle, outside the root canal, as shown in the figures, this flexible collar 8 extends radially relative to the active part 1 and its longitudinal axis A-A and is located between the tip 3 and the openings 5. This flexible collar 8 is arranged to deform when it encounters the walls of said canal during insertion or removal of the needle and to thus prevent damaging the canal. The flexible collar 8 has a dual function of preventing the needle from being inserted beyond the apex inside the canal and of acting as a barrier or plug in order to prevent the irrigation solution from exceeding the apex and reaching the periapical tissue. Indeed, by deforming when the needle is inserted into the canal, the flexible collar 8 forms a concave element (deformed towards the first end 2) capable of partly blocking and of redirecting the flow of irrigation solution towards the first end 2 of the needle and towards the top of the root canal.

The irrigation needle according to this variant provided with a flexible collar 8 is also obtained by thermoplastic micro-injection moulding with the suitable mould, with the use of plastic materials providing the flexibility for said collar.

According to a second variant of the invention shown in detail in FIGS. 10 to 13, the irrigation needle further comprises a projection 9 located inside the central channel 4 of the active part 1 at the closed end of said channel close to the tip 3. This projection 9 extends parallel to the longitudinal axis A-A of the active part towards the first end 2. This projection 9 can be cylindrical, as shown, or even conical.

The projection 9 is arranged inside the central channel 4 and is designed to create a phenomenon of turbulence in the irrigation solution when said solution passes through the central channel 4, so that the flow of irrigation solution that is initially directed towards the tip 3 of the active part 1 under the action of the irrigation device is redirected, upon encountering the projection 9, towards the first end 2 of the needle. Therefore, at least part of the flow of irrigation solution is distributed via the openings 5, while said flow is directed towards the first end 2 of the needle, which means that said flow is discharged from the openings 5 towards the first end and not towards the tip 3. Consequently, the presence of the projection 9 further limits the amount of the flow of irrigation solution that flows from the openings 5 towards the tip 3 of the needle and thus the apex of the canal.

The irrigation needle according to this second variant is also obtained using a thermoplastic micro-injection method, the corresponding mould comprising the features required to produce the projection 9.

Of course, the aforementioned variants can be combined in order to obtain an irrigation needle provided with a flexible collar 8 and with a projection 9, with this combination exhibiting all the advantages of these variants.

The irrigation needle according to the invention is effective and safe since it allows proper distribution of the irrigation solution to be provided to ensure proper cleaning of the canal, whilst limiting the risk of the solution exceeding the apex and reaching the periapical tissue by virtue of the shape of the openings and/or of the collar and/or of the projection inside the central channel. Furthermore, by using plastic materials, it is very easy for the flexibility of the needle to be adapted and for very smooth surface finishes to be obtained that limit any damage that could be caused to the canal. The thermoplastic micro-injection method also allows the costs and production times to be reduced since no further machining is required following the demoulding of the needle.

1-9. (canceled)

10. Irrigation needle comprising an active part (1) extending between a first end intended to be connected to an irrigation device and a second closed end (3), a central channel (4) extending inside the active part (1) and open at the first end (2) and at least one opening (5) arranged radially on the active part (1) in the vicinity of the second end (1) and communicating with the central channel (4) for distributing an irrigation solution, wherein the needle is obtained as one piece using a thermoplastic micro-injection moulding method.

11. The irrigation needle as claimed in claim 10, wherein the one or more opening(s) (5) is/are of elongated and bevelled shape and is/are oriented so that the flow of irrigation solution that exits the central channel (4) through the one or more opening(s) (5) is essentially directed towards the first end (2) of the active part (1) of the needle.

12. The irrigation needle as claimed in claim 11, wherein the one or more opening(s) (5) comprise each an inclined plane (6) produced in the wall of the active part (1) and extending from a perforation (7) in the central channel 4 to an outer surface of the active part (1) towards the first end (2).

13. The irrigation needle as claimed in claim 10, further comprising a collar (8) extending radially relative to the active part (1) between the second end (3) and the one or more opening(s) (5), the collar (8) being flexible and deformable.

14. The irrigation needle as claimed in claim 10, further comprising a projection (9) extending inside the central channel (4) from the second end (3) and arranged to create a phenomenon of turbulence when the flow of irrigation solution injected into the central channel (4) through the first end (1) of the needle encounters said projection (9), the phenomenon of turbulence causing a change of direction of at least one part of the flow of irrigation solution that is then redirected towards the first end (1), so that said part of the flow is discharged through the one or more opening(s) (5) towards the first end (2) and not towards the second end (3).

15. The irrigation needle as claimed in claim 10, wherein the active part (1) is flexible, with increasing flexibility from the first end (2) to the second end (3).

16. The irrigation needle as claimed in claim 10, wherein the active part (1) is conical, tapering from the first end (2) to the second end (3).

17. The irrigation needle as claimed in claim 10, comprising a thermoplastic material such as polyethylene or polypropylene.

18. The irrigation needle as claimed in claim 10, comprising a high-flow plastic material.

19. An endodontic irrigation system comprising an irrigation needle as claimed in claim 10.

20. The irrigation needle as claimed in claim 11, further comprising a collar (8) extending radially relative to the active part (1) between the second end (3) and the one or more opening(s) (5), the collar (8) being flexible and deformable.

21. The irrigation needle as claimed in claim 12, further comprising a collar (8) extending radially relative to the active part (1) between the second end (3) and the one or more opening(s) (5), the collar (8) being flexible and deformable.

22. The irrigation needle as claimed in claim 11, further comprising a projection (9) extending inside the central channel (4) from the second end (3) and arranged to create a phenomenon of turbulence when the flow of irrigation solution injected into the central channel (4) through the first end (1) of the needle encounters said projection (9), the phenomenon of turbulence causing a change of direction of at least one part of the flow of irrigation solution that is then redirected towards the first end (1), so that said part of the flow is discharged through the one or more opening(s) (5) towards the first end (2) and not towards the second end (3).

23. The irrigation needle as claimed in claim 12, further comprising a projection (9) extending inside the central channel (4) from the second end (3) and arranged to create a phenomenon of turbulence when the flow of irrigation solution injected into the central channel (4) through the first end (1) of the needle encounters said projection (9), the phenomenon of turbulence causing a change of direction of at least one part of the flow of irrigation solution that is then redirected towards the first end (1), so that said part of the flow is discharged through the one or more opening(s) (5) towards the first end (2) and not towards the second end (3).

24. The irrigation needle as claimed in claim 13, further comprising a projection (9) extending inside the central channel (4) from the second end (3) and arranged to create a phenomenon of turbulence when the flow of irrigation solution injected into the central channel (4) through the first end (1) of the needle encounters said projection (9), the phenomenon of turbulence causing a change of direction of at least one part of the flow of irrigation solution that is then redirected towards the first end (1), so that said part of the flow is discharged through the one or more opening(s) (5) towards the first end (2) and not towards the second end (3).

25. The irrigation needle as claimed in claim 11, wherein the active part (1) is flexible, with increasing flexibility from the first end (2) to the second end (3).

26. The irrigation needle as claimed in claim 12, wherein the active part (1) is flexible, with increasing flexibility from the first end (2) to the second end (3).

27. The irrigation needle as claimed in claim 13, wherein the active part (1) is flexible, with increasing flexibility from the first end (2) to the second end (3).

28. The irrigation needle as claimed in claim 14, wherein the active part (1) is flexible, with increasing flexibility from the first end (2) to the second end (3).

29. The irrigation needle as claimed in claim 17, wherein the thermoplastic material is polyethylene or polypropylene.
